(19) United States
(12) Patent Application Publication
(10) Pub. No.: US 2020/0198092 A1
(43) Pub. Date: Jun. 25, 2020

(54) POLISHING PAD AND COMPOSITION FOR MANUFACTURING THE SAME

(71) Applicant: XIA TAI XIN SEMICONDUCTOR (QING DAO) LTD., Qingdao (CN)

(72) Inventor: KWANG-BOK KIM, Singapore (SG)

(21) Appl. No.: 16/668,376

(22) Filed: Oct. 30, 2019

Related U.S. Application Data
(60) Provisional application No. 62/779,484, filed on Dec. 14, 2018.

(51) Int. Cl. B24B 37/24; C09G 1/02; C09K 3/14; C08G 18/38; C08G 18/48; C08G 18/66; C08G 18/76; C08K 3/04; C08K 7/06; C08K 3/22

(52) U.S. Cl. CPC B24B 37/24; C09G 1/02; C09K 3/1436; C08G 18/3814; C08G 18/4854; C08G 18/6685; C08K 2003/2227; C08G 18/7671; C08K 3/04; C08K 7/06; C08K 3/22; C08K 2201/001; C08G 18/7614

(57) ABSTRACT

The present disclosure provides a composition for manufacturing a polishing pad. The composition includes 15 to 25 wt % of MBCA, 20 to 40 wt % of isocyanates, 30 to 50 wt % of polyols, and 3 to 10 wt % of conductive additive. The conductive additive in the composition is selected from at least one of carbon black, carbon fibers, and alumina particles. The conductive additive is electrically charged.

### CROSS-REFERENCE TO RELATED APPLICATION

This application claims the benefit of and priority to U.S. Provisional Patent Application No. 62/779484 filed on Dec. 14, 2018, the contents of which are incorporated by reference herein.

### FIELD

The present disclosure generally relates to a polishing pad. More specifically, the present disclosure relates to a polishing pad that has surface charges to optimize a chemical mechanical polishing process for a wafer.

### BACKGROUND

Chemical mechanical polishing or chemical mechanical planarization (CMP) is accomplished by holding a semiconductor wafer against a rotating polishing surface or rotating the wafer relative to the polishing surface, under controlled conditions of temperature, pressure, and chemical composition. The polishing surface may be a planar pad formed of a soft and porous material, such as a blown polyurethane. During a CMP process, the polishing surface is wetted with a chemically reactive and abrasive aqueous slurry. The aqueous slurry may be acidic or basic, and typically includes abrasive particles, reactive chemical agents (such as transition metal chelated salts or oxidizers), and adjuvants (such as solvents, buffers, and/or passivating agents). Specifically, chemical etching is performed by the reactive chemical agent in the slurry, whereas mechanical polishing is performed by the abrasive particles in cooperation with the CMP pad. Usually, the CMP process is controlled by adjusting a rotation rate of the wafer. For example, a higher rotation rate of the wafer results in a higher polishing rate, and vice versa. However, it is difficult to precisely control the performance of the CMP process only by adjusting the rotation rate of the wafer.

Accordingly, there remains a need to optimize the performance of the polishing process.

SUMMARY

In view of above, the present disclosure is directed to a polishing pad that carries surface charges to optimize the polishing process of a wafer.

An implementation of the present disclosure is directed to a composition for manufacturing a polishing pad. The composition includes 15 to 25 weight percentage (wt %) of MBCA, 20 to 40 wt % of isocyanates, 30 to 50 wt % of polyols, and 3 to 10 wt % of conductive additive. The conductive additive of the composition is selected from a group comprising carbon black, carbon fibers, and alumina particles. The conductive additive is electrically charged.

Another implementation of the present disclosure is directed to a polishing pad manufactured from a composition. The composition includes 15 to 25 wt % of MBCA, 20 to 40 wt % of isocyanates, 30 to 50 wt % of polyols, and 3 to 10 wt % of conductive additive.

The conductive additive in the composition is selected from at least one of a group consisting of carbon black, carbon fibers, and alumina particles. The conductive additive is electrically charged. The polishing pad includes a first pad and a second pad. The conductive additive in the composition for manufacturing the first pad is positively charged. The conductive additive in the composition for manufacturing the second pad is negatively charged.

Another implementation of the present disclosure is directed to a method of manufacturing a polishing pad. The method includes actions S401 to S403. In action S401, a composition for manufacturing the polishing pad is provided. The composition includes 15 to 25 wt % of MBCA, 20 to 40 wt % of isocyanates, 30 to 50 wt % of polyols, and 3 to 10 wt % of conductive additive. The conductive additive in the composition is selected from a group comprising carbon black, carbon fibers, and alumina particles. The conductive additive is electrically charged. In action S402, the composition is casted into an open mold. In action S403, the composition is heated to cure and generate a polyurethane resin foam.

Still another implementation of the present disclosure is directed to a CMP apparatus for polishing a wafer. The CMP apparatus includes a platen, a retaining ring, and a carrier head. The platen has a polishing pad for polishing the wafer. The polishing pad is manufactured from a composition including 15 to 25 wt % of MBCA, 20 to 40 wt % of isocyanates, 30 to 50 wt % of polyols, and 3 to 10 wt % of conductive additive. The conductive additive in the composition is selected from a group comprising carbon black, carbon fibers, and alumina particles. The conductive additive is electrically charged. The retaining ring is configured to hold the wafer. The carrier head is connected to the retaining ring and configured to rotate the retaining ring.

As described above, the polishing pad of the implementations of the present disclosure is manufactured from a composition having urethane prepolymers and a conductive additive. The conductive additive in the composition is electrically charged. Therefore, the polishing pad manufactured by the composition of the implementations of the present disclosure carries surface charges that interact with the electrical charges in the slurry and the wafer, and hence optimizes the performance of the polishing process.

### BRIEF DESCRIPTION OF THE DRAWINGS

Implementations of the present technology will now be described, by way of example only, with reference to the attached figures.

FIG. 1 is a schematic diagram of a chemical mechanical polishing (CMP) apparatus according to an implementation of the present disclosure.

FIGS. 2A and 2B are schematic diagrams showing effects of surface charges of a polishing pad of the CMP apparatus in FIG. 1.

FIGS. 3A and 3B are top views of various implementations of the polishing pad of FIG. 1.

FIG. 4 is a flowchart of a method for manufacturing a polishing pad of according to another implementation of the present disclosure.

### DETAILED DESCRIPTION

The present disclosure will now be described more fully hereinafter with reference to the accompanying drawings, in which example implementations of the disclosure are shown. This disclosure may, however, be implemented in many different forms and should not be construed as limited to the example implementations set forth herein. Rather, these example implementations are provided so that this disclosure will be thorough and complete, and will fully convey the scope of the disclosure to those skilled in the art. Like reference numerals refer to like elements throughout.

The terminology used herein is for the purpose of describing particular example implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, actions, operations, elements, and/or components, but do not preclude the presence or addition of one or more other features, regions, integers, actions, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

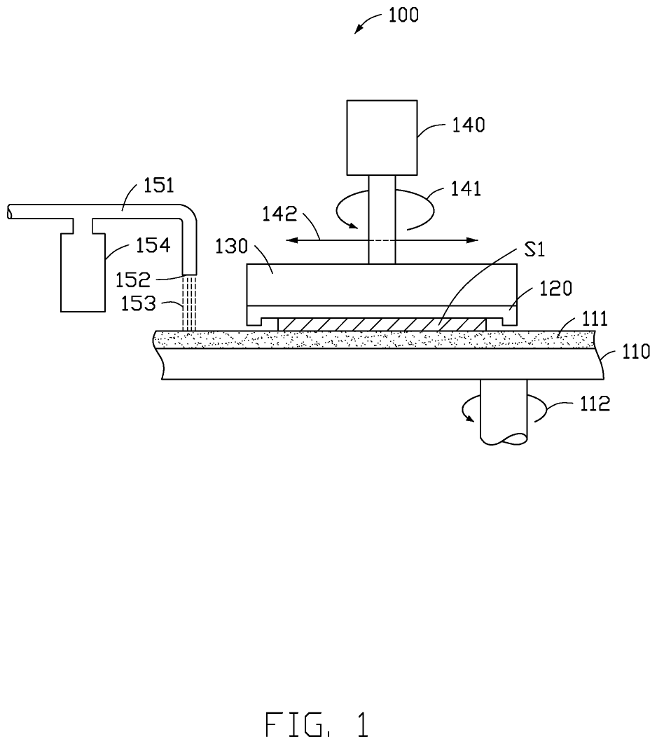

The description will be made as to the example implementations of the present disclosure in conjunction with the accompanying drawings in FIGS. 1 to 4. Reference will be made to the drawing figures to describe the present disclosure in detail, wherein depicted elements are not necessarily shown to scale and wherein like or similar elements are designated by same or similar reference numeral through the several views and same or similar terminology.

The present disclosure will be further described hereafter in combination with the accompanying figures.

Referring to FIG. 1, a schematic diagram of a chemical mechanical polishing (CMP) apparatus 100 according to an implementation of the present disclosure is illustrated. The CMP apparatus 100 includes a carrier head 130 and a retaining ring 120. A semiconductor wafer S1 is held by the retaining ring 120. A soft pad (not shown in the figure) is positioned between the retaining ring 120 and the wafer S1, with the wafer S1 being held against the soft pad by a partial vacuum or an adhesive. The carrier head 130 is provided to be continuously rotated by a drive motor 140, in the direction 141, and optionally be reciprocated transversely in the directions 142. Accordingly, the combined rotational and transverse movements of the wafer S1 are intended to reduce the variability in the material removal rate across the surface of the wafer S1. The CMP apparatus 100 further includes a platen 110, which is rotated in the direction 112. A polishing pad 111 is mounted on the platen 110. As compared to the wafer S1, the platen 110 is provided with a relatively large surface area to accommodate the transverse movements of the wafer S1 on the retaining ring 120 across the surface of the polishing pad 111. A supply tube 151 is mounted above the platen 110 to deliver a stream of polishing slurry 153, which is dripped onto the surface of the polishing pad 111 from a nozzle 152 of the supply tube 151. The slurry 153 may be gravity fed from a tank or reservoir (not shown), or otherwise pumped through the supply tube 151. Alternatively, the slurry 153 may be supplied from below the platen 110 such that it flows upwardly through the underside of the polishing pad 111. In another implementation, the slurry 153 may be supplied from within the retaining ring 120 by nozzles disposed in the retaining ring 120. If the particles in the slurry 153 forms agglomeration of undesirable large particles, the wafer surface would be scratched when the wafer S1 is being polished. Therefore, the slurry 153 needs to be filtered to remove the undesirable large particles. Usually, a filter assembly 154 is coupled to the supply tube 151 to capture agglomerated or oversized particles. The slurry 153 and the surface of the wafer S1 may be electrically charged due ions in the slurry 153 and/or static charges accumulated in the polishing process.

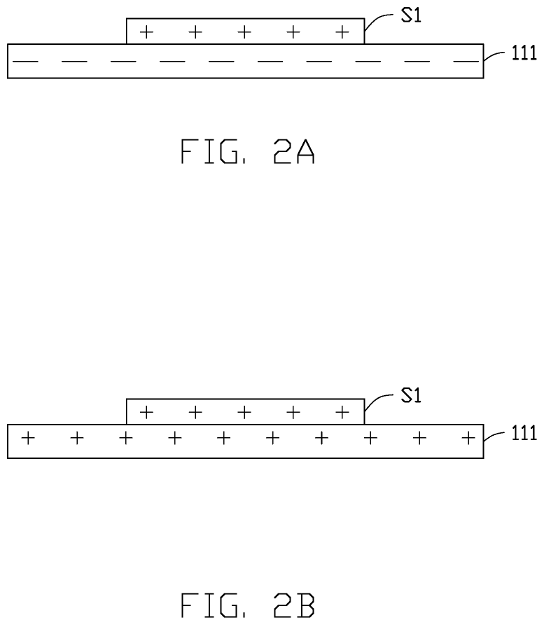

In an implementation, the polishing pad 111 is a polyurethane polishing pad that carries surface charges. The polishing pad 111 of the present implementation is a polyurethane polishing pad having a conductive additive. The conductive additive allows the pad surface to carry surface charges to optimize in-wafer polishing characteristics (such as removal rate, selectivity, and recess). Referring to FIGS. 2A and 2B, schematic diagrams showing effects of surface charges of the polishing pad 111 during the polishing process are illustrated. As shown in FIG. 2A, when polishing a wafer S1 that carries positive surface charges, using a polishing pad 111 that carries negative charges could increase the removal rate of the polishing process due to the attraction force between the wafer S1 and the polishing pad 111. On the other hand, as shown in FIG. 2B, if the polishing pad 111 carries positive charges, the removal rate of the polishing process for the wafer S1 would be decreased due to the repulsion force between the wafer S1 and the polishing pad. Therefore, by adjusting the electric charges and their charge distribution on the polishing pad 111, the polishing characteristics (such as removal rate, selectivity, and recess) can be managed.

According to another implementation of the present disclosure, the polishing pad 111 may be manufactured from a composition that includes a plurality of urethane prepolymers and a curative (or hardener) that cross-links the urethane prepolymers. The urethane prepolymers are formed by reacting polyols (e.g., polyether and/or polyester polyols) with difunctional or polyfunctional isocyanates. The isocyanates used for preparing the urethane prepolymers may be methylene diphenyl diisocyanate (MDI) and/or toluene diisocyanate (TDI). The curative in the composition may be a compound or mixture of compounds used to cross-link, therefore cure or harden, the urethane prepolymers. Specifically, the curative reacts with isocyanates, causing the chains of the urethane prepolymers to link together to form the polyurethane. The curative may include 4,4′-methylene-bis(2-chloroaniline) (MBCA; also referred to by the tradename of MOCA®). In one implementation, the composition includes 15 to 25 weight percentage (wt %) of MBCA, 20 to 40 wt % of isocyanates, 30 to 50 wt % of polyols, and 3 to 10 wt % of conductive additive. Typically, the prepolymers (e.g., isocyanates and polyols) are in a weight percentage within a range of 70 to 90 wt % in the composition. Preferably, the weight percentage of the conductive additive is within a range of 5 to 10 wt %. The conductive additive in the composition is selected from a group comprising carbon black, carbon fibers, and alumina particles. The conductive additive is electrically charged. The conductive additive may also be conductive nanoparticles, such as carbon nanoparticles or carbon nanotubes. The alumina particles may be alumina sphere particles.

By adjusting the weight percentage of the conductive additive and the electrical charges carried by the conductive additive, the characteristics of the polishing pad formed by the composition can be managed. In one implementation, the conductive additive is positively charged, therefore the polishing pad formed by the composition carries positive surface charges and has higher removal rate to a negatively charged wafer. On the other hand, the polishing pad that carries positive surface charges has lower removal rate to a positively charged wafer. In some implementations, the conductive additive is negatively charged, therefore the polishing pad formed by the composition carries negative surface charges and has lower removal rate to a negatively charged wafer. On the other hand, the polishing pad that carries negative surface charges has higher removal rate to a positively charged wafer.

Therefore, the polishing pad manufactured by the composition of the implementations of the present disclosure carries surface charges that interact with the electrical charges of the slurry and the wafer, and hence optimizes the performance of the polishing process. Also, the conductivity of the polishing pad manufactured by the composition of the implementations of the present disclosure can be adjusted according to different requirements of the polishing process.

Preferably, the conductive additive has a conductivity of 1 to 30 millisiemens/centimeter (mS/cm) and a Zeta potential of −200 to 100 millivolt (mV). The isocyanates in the composition may include at least one of TDI and MDI. The polyols may be poly(tetramethylene ether)glycol (PTMG). Furthermore, the prepolymers in the composition are often characterized by the weight percentage of unreacted isocyanate groups (NCO %) present in the prepolymer. In one implementation, the composition has an NCO % within the range of 0.1 to 10 wt %, preferably 3 to 10 wt %.

The weight percentage of the curative may affect the hardness of the resulting polishing pad. Typically, the polishing pad has a hardness of around 60 Shore D. The composition for manufacturing the polishing pad may further include other ingredients, such as surfactants, fillers, catalysts, processing aids, antioxidants, stabilizers, and/or lubricants.

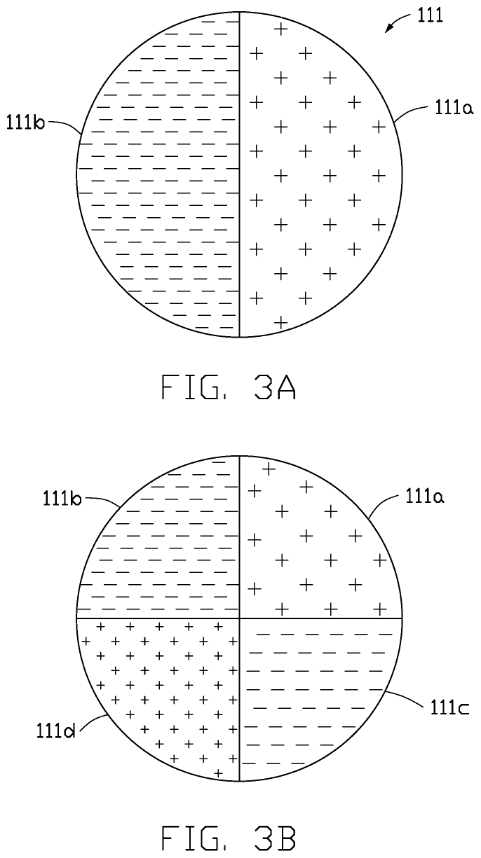

In some implementations, the polishing pad may be a composited polishing pad. Referring to FIGS. 3A and 3B, top views of various implementations of the composited polishing pad are illustrated. In one implementation, as shown in FIG. 3A, the polishing pad 111 is a composited polishing pad including a first pad 111a and a second pad 111b. The first pad 111a carries positive surface charges, and the second pad 111b carries negative charges. The first pad 111a and the second pad 111b are manufactured by the composition of the previous implementations. Specifically, the conductive additive in the composition for manufacturing the first pad 111a is positively charged; and the conductive additive in the composition for manufacturing the second pad 111b is negatively charged. In another implementation, as shown in FIG. 3B, the polishing pad 111 is a composited pad of a first pad 111a, a second pad 111b, a third pad 111c, and a fourth pad 111d. The first pad 111a and the fourth pad 111d carry positive surface charges, and the second pad 111b and the third pad 111c carry negative surface charges. Specifically, the conductive additive in the compositions for manufacturing the first pad 111a and the fourth pad 111d is positively charged; and the conductive additive in the compositions for manufacturing the second pad 111b and the third pad 111c is negatively charged. Also, the composition for manufacturing the first pad 111a may have a lower weight percentage of the conductive additive than that of the fourth pad 111d, and the composition for manufacturing the second pad 111b may have a higher weight percentage of the conductive additive than that of the third pad 111c.

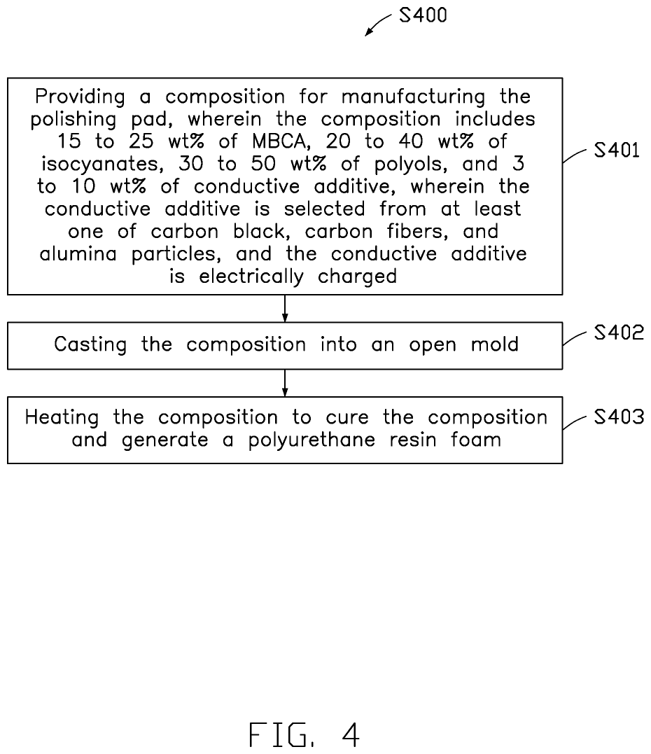

Referring FIG. 4, a flowchart of a method S400 of manufacturing a polishing pad according to another implementation is illustrated. As shown in FIG. 4, the method S400 includes actions S401, S402, and S403. In action S401, a composition for manufacturing the polishing pad is provided. The composition can be referred to the previous implementations. The composition includes 15 to 25 wt % of MBCA, 20 to 40 wt % of isocyanates, 30 to 50 wt % of polyols, and 3 to 10 wt % of conductive additive. The conductive additive in the composition is selected from a group comprising carbon black, carbon fibers, and alumina particles. The conductive additive is electrically charged. In action S402, the composition is casted into an open mold. For example, the open mold is a pan-type open mold. In action S403, the composition is heated to cure and generate a polyurethane resin foam. In one implementation, the composition is heated to and maintained at 90° C. to 150° C. for 5 to 10 hours for curing. The polyurethane resin foam is then sliced into various polishing pads of desirable thickness and shapes.

In yet another implementation of the present disclosure also is directed to a CMP apparatus for polishing a wafer. The CMP apparatus can be referred to the CMP apparatus 100 of FIG. 1. The CMP apparatus 100 includes a platen 110, a retaining ring 120, a carrier head 130, and a supply tube 151. The platen 110 has a polishing pad 111 for polishing the wafer S1 with a slurry 153. The retaining ring 120 is configured to hold the wafer S1. The carrier head 130 is connected to the retaining ring 120 and configured to rotate the retaining ring 120. The supply tube 151 is configured to provide the slurry 153 to the polishing pad 111 of the platen 110. The CMP apparatus 100 further includes a drive motor 140 connected to the carrier head 130, and a filter assembly 154 connected to the supply tube 151. The drive motor 140 rotates the carrier head 130 in the direction 141, and optionally reciprocates transversely in the directions 142. The filter assembly 154 is configured to capture large particles (e.g., agglomerated particles) in the slurry 153 to prevent the large particles from causing defects on the surface of the wafer S1.

The polishing pad 111 of the platen 110 may be a polyurethane polishing pad manufactured from a composition. The composition can be referred to the previous implementations. The composition may include 15 to 25 wt % of MBCA, 20 to 40 wt % of isocyanates, 30 to 50 wt % of polyols, and 3 to 10 wt % of conductive additive. The conductive additive in the composition is selected from a group comprising carbon black, carbon fibers, and alumina particles. The conductive additive is electrically charged. The details of the composition and the manufacturing method of the polishing pad 111 can be referred to previous implementations without further description herein.

As described above, the polishing pad of the implementations of the present disclosure is manufactured from a composition having urethane prepolymers and a conductive additive. The conductive additive in the composition is electrically charged. Therefore, the polishing pad manufactured by the composition of the implementations of the present disclosure carries surface charges that interact with the electrical charges in the slurry and the wafer, and hence optimizes the performance of the polishing process.

The implementations shown and described above are only examples. Many details are often found in the art such as the other features of a polishing pad and a composition for manufacturing the same. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the implementations described above may be modified within the scope of the claims.

What is claimed is:

1. A composition for manufacturing a polishing pad, the composition comprising:
15 to 25 weight percentage (wt %) of 4,4′-methylene-bis(2-chloroaniline) (MBCA);
20 to 40 wt % of isocyanates;
30 to 50 wt % of polyols; and
3 to 10 wt % of conductive additive, wherein the conductive additive is selected from a group comprising carbon black, carbon fibers, and alumina particles, and the conductive additive is electrically charged.

2. The composition of claim 1, wherein the conductive additive has a conductivity within a range of 1 to 30 mS/cm.

3. The composition of claim 1, wherein the conductive additive has a Zeta potential within a range of −200 to 100 mV.

4. The composition of claim 1, wherein the isocyanates comprise at least one of toluene diisocyanate (TDI) and methylene diphenyl diisocyanate (MDI).

5. The composition of claim 1, wherein the polyols are poly(tetramethylene ether)glycol (PTMG).

6. The composition of claim 1, wherein the conductive additive is positively charged.

7. The composition of claim 1, wherein the conductive additive is negatively charged.

8. The composition of claim 1, wherein the composition has a weight percentage of unreacted isocyanate groups (NCO %) within a range of 0.1 to 10 wt %.

9. The composition of claim 8, wherein the NCO % of the composition is within a range of 3 to 10 wt %.

10. The composition of claim 1, wherein a weight percentage of the conductive additive is within a range of 5 to 10 wt %.

11. A polishing pad manufactured from a composition, the composition comprising:
15 to 25 wt % of MBCA;
20 to 40 wt % of isocyanates;
30 to 50 wt % of polyols; and
3 to 10 wt % of conductive additive, wherein the conductive additive is selected from a group comprising carbon black, carbon fibers, and alumina particles, and the conductive additive is electrically charged, and the polishing pad comprising a first pad and a second pad, wherein the conductive additive in the composition for manufacturing the first pad is positively charged, and the conductive additive in the composition for manufacturing the second pad is negatively charged.

12. The polishing pad of claim 11, wherein the isocyanates in the composition comprise at least one of TDI and MDI.

13. The polishing pad of claim 11, wherein the polyols in the composition are PTMG.

14. The polishing pad of claim 11, wherein the composition has a NCO % within a range of 0.1 to 10 wt %.

15. The polishing pad of claim 11, wherein a weight percentage of the conductive additive is within a range of 5 to 10 wt %.

16. A method of manufacturing a polishing pad, the method comprising:
providing a composition for manufacturing the polishing pad, wherein the composition comprises:
15 to 25 wt % of MBCA;
20 to 40 wt % of isocyanates;
30 to 50 wt % of polyols; and
3 to 10 wt % of conductive additive, wherein the conductive additive is selected from at least one of a group consisting of carbon black, carbon fibers, and alumina particles, and the conductive additive is electrically charged;
casting the composition into an open mold; and
heating the composition to cure the composition and generate a polyurethane resin foam.
